(19) United States
(12) Patent Application Publication
(10) Pub. No.: US 2012/0249016 A1
(43) Pub. Date: Oct. 4, 2012

(54) QUICK CHANGE BASE SUPPORTING FLUORESCENT BALLASTS AND/OR LIGHT EMITTING DIODE POWER SUPPLIES

(76) Inventor: Toby Smith, Gilroy, CA (US)

(21) Appl. No.: 13/418,205

(22) Filed: Mar. 12, 2012

Related U.S. Application Data
(60) Provisional application No. 61/451,982, filed on Mar. 11, 2011.

(51) Int. Cl. H05B 37/00; H05B 41/14

(52) U.S. Cl. 315/320; 315/312; 315/324

(57) ABSTRACT

Embodiments of the invention comprise a base and a light emitting diode (LED) power supply (PS) detachably connectable to the base module. The LED PS provides current and voltage to at least one LED lamp in a lighting fixture. The base optionally includes electrical connections for detachable connection of a ballast and further includes electrical connections to mains electrical power. An embodiment may further include the ballast. The LED PS, base, and ballast implement a common electrical and mechanical interface for enabling replacement of fluorescent lamps in lighting fixtures with LED lamps. A lamp including a base is included in some embodiments of the invention.

### CROSS REFERENCE TO RELATED APPLICATIONS

This application claims the benefit of U.S. Provisional Application No. 61/451,982, filed Mar. 11, 2011, incorporated herein by reference in its entirety.

### FIELD OF THE INVENTION

Light fixtures, and in particular a base providing a common mechanical and electrical interface for a fluorescent lamp ballast and for a power supply for a light emitting diode (LED) lamp.

### BACKGROUND

A fluorescent lamp converts electrical power into light more efficiently than an incandescent lamp for the same amount of illumination. A fluorescent lamp requires a ballast to provide a high voltage for initiating current flow through the lamp and for limiting current flow to a predetermined maximum value while the lamp is producing light. When an electrical failure occurs in a ballast or in electrical connections to the ballast, it may be necessary to employ the services of a trained electrician to replace the failed ballast by cutting and splicing wires in a light fixture to remove the failed ballast and install a new ballast. Replacing a failed ballast in a light fixture with another ballast having incorrect specifications for the number or type of fluorescent lamps in the fixture, making an error in electrical connections to the replacement ballast, or failing to remove electrical power from the light fixture before initiating repairs may lead to a risk of further damage to the lighting fixture or wiring, risk human exposure to hazardous voltages and currents, and may cause a fire. It may be necessary to remove a lighting fixture from a ceiling or wall or disassemble the lighting fixture before the ballast can be replaced.

Lamps using light emitting diodes (LEDs) use less electrical power than fluorescent lamps for the same amount of illumination, and much less electrical power than incandescent lamps. As the cost of LED lamps falls, there is increasing incentive for replacing fluorescent lamps with LED lamps. It would be desirable to be able to convert previously installed light fixtures from operation with fluorescent lamps to operation with LED lamps. A lighting fixture that has been wired for operation with fluorescent lamps may require modification to the wiring connections in the fixture before the fixture is suitable for use with LED lamps, and vice versa. However, LED lamps may be damaged if they are subjected to excessively high input voltage or excessively high current, and therefore may require a power supply which holds output voltage and current within a predetermined range selected to provide a desired amount of light output without causing damage to the LEDs. Converting a light fixture from operating with fluorescent lamps or incandescent lamps to LED lamps may require the services of a trained electrician to make sure that the power for the LEDs is supplied with the correct voltage, polarity, and current limits. An error in wiring connections to an LED lamp can damage or destroy the LEDs.

Power supplies for LEDs may dissipate enough heat while providing electrical power to LED lamps to shorten the lifetime of the power supply, degrade power supply performance, or damage power supply components and cause power supply failure. It would therefore be desirable to replace old, degraded, or damaged LED power supplies in lighting fixtures without requiring an electrician to cut and splice wires that could be carrying voltage and current.

### SUMMARY

Embodiments of the invention include a light emitting diode power supply (LED PS) module having a plurality of pin electrical contacts providing for all electrical connections to mains power input and any light emitting diode (LED) lamps and a wired base having a plurality of socket electrical contacts for electrical and mechanical connection to the corresponding plurality of pin electrical contacts in the LED PS module and for providing intermediate wiring between the LED PS module and mains power input and any LED lamps. The LED PS module may further include two quick turn fasteners providing for removable mechanical connection of the LED PS module to the wired base.

Other embodiments of the invention include an LED PS module having a plurality of pin electrical contacts providing for all electrical connections to mains power input and any LED lamps and a wired base. The wired base includes a first plurality of socket electrical contacts disposed near an LED end of the base for electrical and mechanical connection to the corresponding plurality of pin electrical contacts in the LED PS module and for providing intermediate wiring between the LED PS module and mains power input and any LED lamps. The wired base further includes a second plurality of socket electrical contacts disposed near a fluorescent end of the base for electrical and mechanical connection to a corresponding plurality of pin electrical contacts in a ballast module.

Still other embodiments of the invention include a ballast module having a plurality of pin electrical contacts providing for all electrical connections to mains power input and any fluorescent lamps and the wired base. Other embodiments of the invention optionally include a lamp fixture with the base attached to the lamp fixture. Some lamp fixture embodiments of the invention are convertible from operation with fluorescent lamps to operation with LED lamps by replacing a ballast module connected to the base with an LED PS module connected to the base.

This section summarizes some features of embodiments of the invention. These and other features, aspects, and advantages will become better understood with regard to the following description and upon reference to the following drawings.

### BRIEF DESCRIPTION OF THE DRAWINGS

FIG. 1 shows an example embodiment of a base having an electrical and mechanical interface for an LED power supply and for a fluorescent ballast.

FIG. 2 is an example of an alternative embodiment of a base having an electrical and mechanical interface for an LED power supply.

FIG. 3 is an example of an alternative embodiment of a base having an electrical and mechanical interface for a fluorescent ballast.

FIG. 4 is an example embodiment of an LED power supply electrically and mechanically connected to the example of a base of FIG. 1.

FIG. 5 is an example embodiment of a ballast electrically and mechanically connected to the example of a base of FIG. 1.

FIG. 6 is an example embodiment of an LED power supply electrically and mechanically connected to the example of a base of FIG. 2.

FIG. 7 is an example of a ballast electrically and mechanically connected to the example embodiment of a base of FIG. 3.

FIG. 8 is a pictorial view of the example embodiments of a ballast and a base of FIG. 5.

FIG. 9 is a pictorial view of the example embodiments of an LED power supply and base of FIG. 4.

FIG. 10 is a pictorial view of an example embodiment of a base to which either an LED power supply embodiment or a ballast embodiment may be electrically and mechanically connected and disconnected without cutting or splicing any wires in a light fixture.

FIG. 11 is a schematic diagram of an example of electrical connections in a lighting fixture which includes the example embodiment of a base from FIGS. 1, 5, and 10.

FIG. 12 is an example embodiment of a light fixture which includes the example of a base from FIG. 2 and the example of an LED power supply from FIGS. 4, 6, and 9.

### DESCRIPTION

Embodiments of the invention comprise a base module adapted for electrical and mechanical connection to a light fixture and for removable connection to a fluorescent ballast module and to an LED power supply module. Some embodiments of a base module include a common electrical and mechanical interface for LED power supply modules. Other embodiments of a base module include a common electrical and mechanical interface for a fluorescent ballast module. Some embodiments of a base module include common mechanical and electrical interfaces for both a ballast module and for an LED power supply module. Some embodiments of the invention comprise a light fixture and a base module.

A base module embodiment of the invention, also referred to herein as a base, includes electrical connectors for quickly and safely making electrical connections to either an LED power supply module or to a ballast module. The base further includes at least one power coupling for supplying voltage and current to lamp sockets adapted to hold at least one optional LED lamp, or alternately at least one optional fluorescent lamp. An LED power supply module embodiment of the invention, also referred to herein as an LED power supply (LED PS), includes electrical couplings for making removable electrical connections to a base and mechanical couplings for holding the LED PS firmly against the base. An LED PS also includes an electronic power supply having output voltage and current selected for powering a selected number of LED lamps in a lighting fixture. Electronic power supply designs suitable for use in an LED PS embodiment of the invention are well known in the art and will not be described herein.

Similarly, a ballast module embodiment of the invention, also referred to herein as a ballast, includes electrical couplings for making removable electrical connections to a base and mechanical couplings for holding the ballast firmly against the base. A ballast embodiment of the invention includes components for a fluorescent light ballast circuit matched to the type of fluorescent lamp to be installed in a selected light fixture. Ballast circuit designs suitable for use in a ballast module embodiment of the invention are well known in the art and will not be described herein.

A base module embodiment of the invention enables a ballast or LED power supply to be removed from a light fixture, for example to replace a damaged module, without cutting or splicing any wires and without exposing a person performing the replacement to hazardous voltages or currents. A module to be replaced is removed from a light fixture by loosening captive mechanical couplings on the module and pulling the module away from the base to interrupt electrical connections between pins in the module and sockets in the base. A new module may be connected to the base by engaging electrical and mechanical couplings on the module with corresponding electrical and mechanical couplings on the base. Ballasts and LED power supplies may be uninstalled and reinstalled against a base in a lighting fixture by persons with basic maintenance skills, for example by someone who is familiar with procedures for replacement of removable lamps in light fixtures, rather than by an electrician or other trained person who is familiar with procedures for safely disconnecting and reconnecting wires which may be energized with high voltage and current.

Embodiments of the invention comprise separable modules adapted for electrical and mechanical connection to one another. A module refers to an enclosure containing other components. Electrical connection between two components refers to an arrangement wherein electrical current may flow from one of the components to the other. Mechanical connection between two components refers to two components in physical contact with one another. Mechanical connection may be referred to as attachment or engagement. Unless otherwise stated, two components which are mechanically connected are separable as part of the normal function of the components, without requiring disassembly of either component or of any structure to which the components may be attached. A mechanical coupling refers to a device for making a mechanical connection to a corresponding mating part. Two components which are electrically connected may not be mechanically connected. Two components which are not intended to be separated may be referred to as joined rather than mechanically connected. Regarding structures used to make electrical connections, a pin refers an electrical contact which may be used to establish an electrical connection to its corresponding mating contact, a socket. A pin may be referred to as a male coupling. A socket may be referred to as a female coupling, a jack, or as a female slot. Any shapes shown for pins or sockets in the figures herein are given as examples; parts with other shapes than those illustrated may be used instead unless otherwise noted.

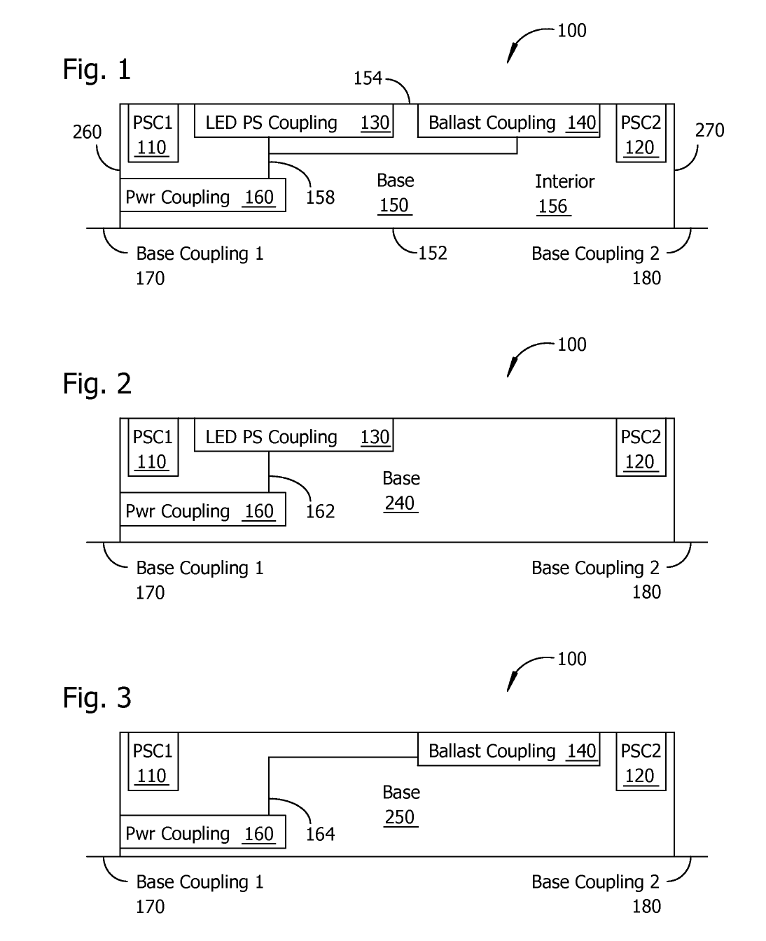

Turning now to the figures, in which the reference designator 100 indicates examples of embodiments of the invention, FIG. 1 shows a simplified block diagram of an example embodiment of a base. A base may include a first plurality of socket electrical contacts disposed near an LED end of the base for electrical and mechanical connection to a corresponding plurality of pin electrical contacts in an LED PS module. The base further provides intermediate wiring between an LED PS module and mains power input and any LED lamps. Mains power input refers to external electrical power supplied to a light fixture or to a combination of a light fixture and a base attached to the light fixture. Mains power may further be input to an optional ballast or to an optional LED power supply through electrical connections to the base. As will be explained later, some embodiments of a base may further include a second plurality of socket electrical contacts disposed near a fluorescent end of the base for electrical and mechanical connection to a corresponding plurality of pin electrical contacts in a ballast module.

In the example embodiment of a base 150 in FIG. 1, a base is formed as a protective enclosure with an interior void for holding the mechanical and electrical couplings used to establish a common electrical and mechanical interface for LED PS and ballast modules. Visible in the interior 156 of the base 156 are a power coupling 160, an LED PS coupling 130, and a ballast coupling 140. Current and voltage pass through the LED PS coupling 130 and ballast coupling 140 for powering one or more lamps electrically connected to power coupling 160, as will be explained in more detail later. The LED PS coupling 130 and the ballast coupling 140 may optionally each be provided with a separate power coupling 160.

The example embodiment of a base 150 in FIG. 1 includes a base coupling 1 170 and a base coupling 2 180 along a bottom side 152 of the base for mechanically attaching the base to a light fixture (light fixture not illustrated). A base may be joined to a light fixture in some implementations and connected to a light fixture in other implementations. One example embodiment of a base 150 has a longest dimension of about 8.4 inches (about 213 millimeters), a width of about 1.7 inches (about 43 millimeters), and a height of about 0.5 inch (about 13 millimeters). The LED PS coupling 130 and ballast coupling 140 are attached to the interior 156 along a top side 154 of the base 150. A first power supply coupler PSC1 110 is attached to the interior 156 along the top side 154 near an LED end 260 of the base 150. A second power supply coupler PSC2 120 is attached to the interior 156 along the top side 154 near a fluorescent end of the base 150. PSC1 110 and PSC2 120 removably engage with corresponding captive fasteners on an LED PS or ballast to mechanically connect the base to either an LED PS embodiment of the invention or to a ballast embodiment of the invention. The power supply couplers PSC1 and PSC2 are preferably located on the top side 154 of the base 150 so that either an LED PS embodiment of the invention or a ballast embodiment of the invention can be easily attached and detached from the base 150. The PSC1 110, PSC2 120, LED PS coupling 130, and ballast coupling 140 along the top side 154 of the base comprise a common mechanical interface for the base 150 and for the ballast and LED PS embodiments of the invention.

The example embodiment of a base from FIG. 1 may optionally be provided with an LED PS coupling but no ballast coupling, as shown in the example of FIG. 2. The example embodiment of a base 240 in FIG. 2 may be advantageous for providing easily replaceable LED PS modules in light fixtures which are intended to carry LED lamps only. In the illustrated example embodiment, PSC1 110 and PSC2 120 may be in the same relative positions in the base 240 as for the example of a base 150 in FIG. 1, that is, there is a common mechanical interface between modules in the examples illustrated.

The example embodiment of a base from FIG. 1 may alternatively be provided with a ballast coupling 140 but no LED PS coupling, as shown in the example of FIG. 3. The example of a base 250 in FIG. 3 may be advantageous for providing easily replaceable ballast modules in light fixtures which are intended to carry fluorescent lamps only. In the illustrated example, PSC1 110 and PSC2 120 may be in the same relative positions in the base 250 as for the example of a base 150 in FIG. 1.

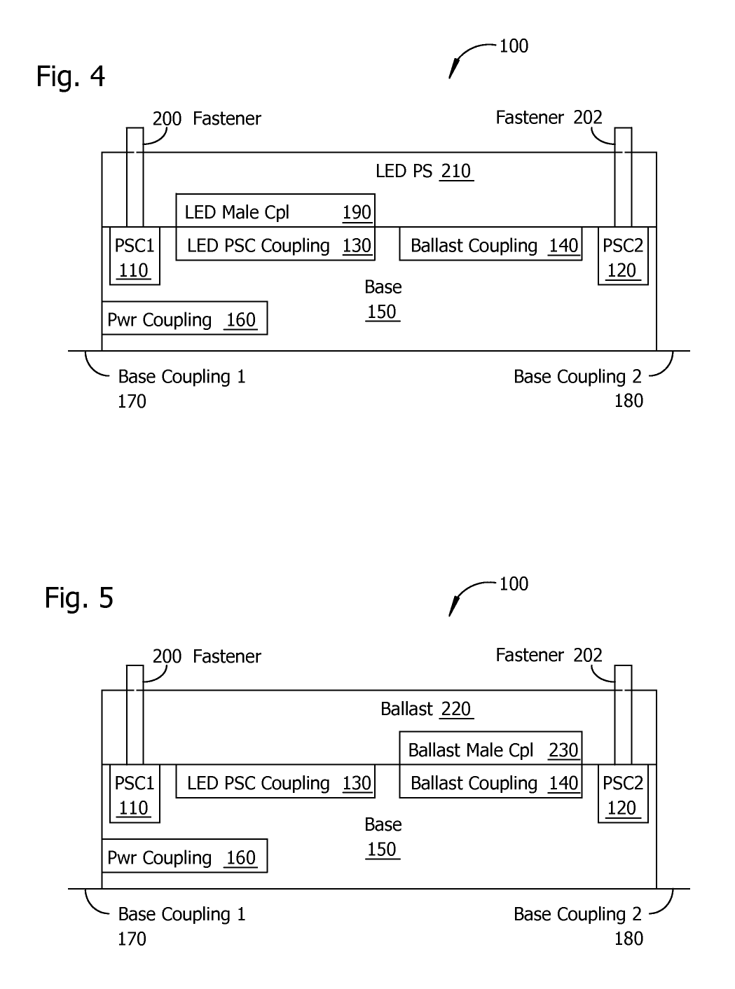

FIG. 4 shows an example embodiment of an LED PS 210 in electrical and mechanical contact with the example of a base 150 from FIG. 1. The LED PS 210 includes a plurality of pin electrical contacts providing for all electrical connections to mains power input and any LED lamps. Mains power refers to external electrical power supplied to a light fixture. The LED PS 210 is firmly and removably held in contact against the base 150 by at least one captive fastener 200. Two captive fasteners 200 are visible in the example of FIG. 4. Each captive fastener may be operated to mechanically engage and disengage with its corresponding mating part, referred to herein as a PS coupling (PS1 110, PS2 120). Examples of fasteners 200 include, but are not limited to, quick-turn fasteners, quarter-turn fasteners, half-turn fasteners, banana plugs and other posts which hold together by deflection of a spring element, latches, and captive threaded bolts. Corresponding mating parts for fasteners 200 include, but are not limited to, quarter-turn receptacles, half-turn receptacles, banana jacks, and captive threaded nuts.

In the example embodiment of FIG. 4, electrical connections between the base 150 and LED PS 210 are made through the LED PSC coupling 130 in the base and the LED male coupling 190 in the LED PS. In some embodiments of a base, an LED PSC coupling 130 and ballast coupling 140 each comprise a plurality of electrical socket contacts. An LED male coupling may comprise a plurality of pin electrical contacts adapted for sliding mechanical engagement with the corresponding mating parts (sockets) to form an electrical connection between the LED PS 210 and the base 150. The LED PSC coupling 130 and ballast coupling 140 may optionally be zero-insertion-force electrical connectors. The LED PSC coupling 130 and ballast coupling 140 may optionally be positioned on the base 150 so that pins in the LED male coupling 190 will not engage with sockets in the ballast coupling 140 when the LED PS 210 is rotated 180 degrees from the orientation shown in FIG. 4 with the fasteners 200 aligned with their corresponding power supply couplings (110, 120).

In the example embodiment of FIG. 5, electrical connections between an example embodiment of a ballast 220 and the example embodiment of a base 150 are made through the ballast male coupling 230 in the ballast 220 and the ballast coupling 140 in the base 150. The ballast male coupling 230 may comprise a plurality of pin electrical contacts adapted for sliding mechanical engagement with corresponding sockets in the base 150 to form an electrical connection between the ballast 220 and the base 150.

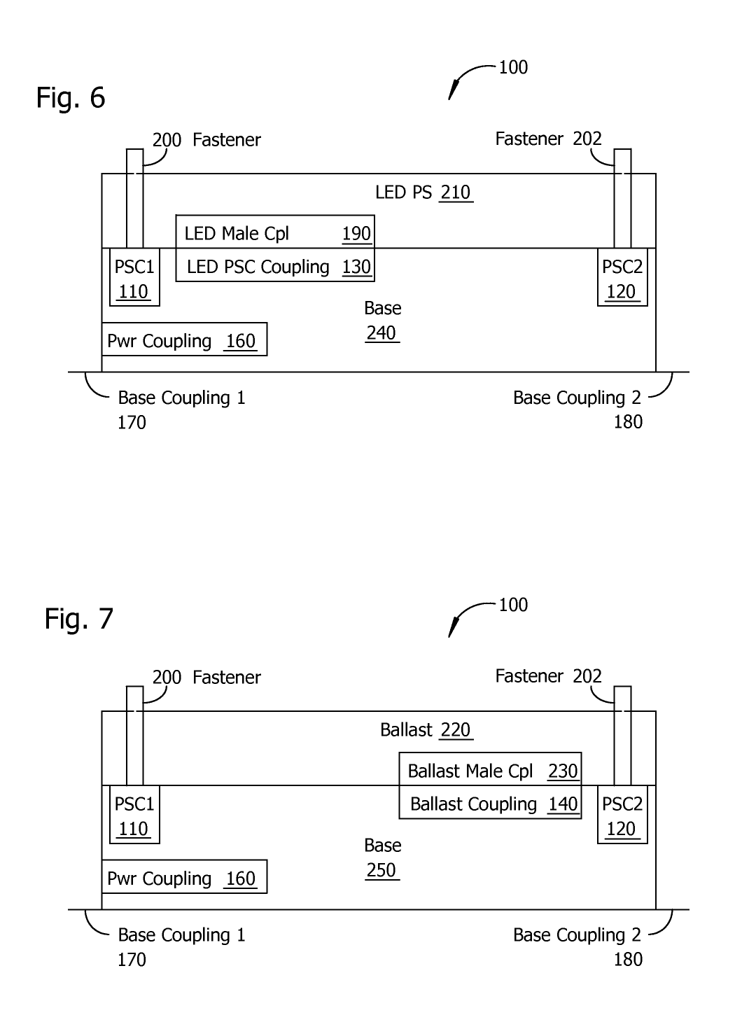

FIG. 6 illustrates an embodiment of the invention 100 comprising an example of a base 240 adapted for electrical connection to an LED PS 210 using the common mechanical interface described previously. The example embodiment of a base 240 in FIG. 6 omits electrical connections for coupling the base to a ballast embodiment of the invention. FIG. 7 illustrates an example embodiment of a base 250 adapted for electrical connection to a ballast 220 but omitting electrical connections for coupling to an LED PS.

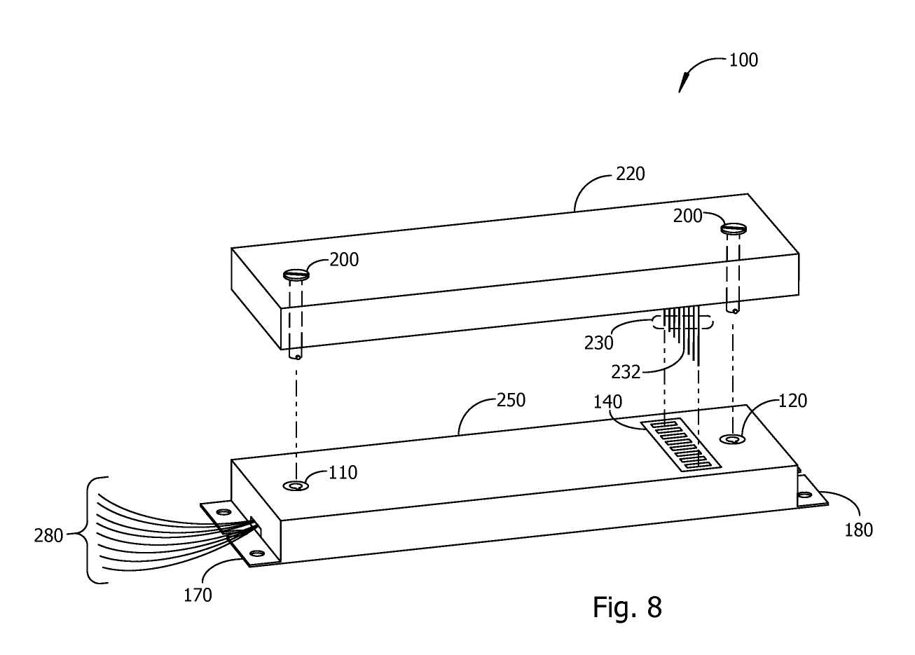

A pictorial view of an example embodiment of a ballast 220 embodiment of the invention 100 in position for engagement with an example of a base 250 is shown in FIG. 8. Alternately, FIG. 8 shows an example of a ballast 220 after it has been detached from a base 250. In the example of FIG. 8, the example embodiment of a ballast 220 includes two captive fasteners 200, one for engaging PSC1 110 and one for engaging PSC2 120. The fasteners 200 and corresponding mating parts PSC1 and PSC 2 may optionally be located so that the captive fasteners will not be aligned with the corresponding couplings (PSC1, PSC2) when the ballast is rotated end-for-end compared to the orientation shown in FIG. 8.

The example embodiment of a ballast 220 in FIG. 8 includes a ballast male coupling 230 comprising a plurality of pins 232 for making electrical connections to corresponding sockets, also referred to as female slots, in the ballast coupling 140 on the base 250. In the illustrated example, the ballast male coupling 230 includes 8 pins 232. Other embodiments of a ballast 220 and base 250 may be adapted for electrical connections using a different number of pins 232. The base 250 in the example of FIG. 8 further includes wire connections 280 to the base, including for example a black wire, a white wire for neutral line connection, a green wire for ground connection, four red wires, one for separate connection to each of four lamp sockets, and a yellow wire for common connection to another four lamp sockets, the eight lamp sockets together providing electrical connections to four lamps. Other embodiments of a base may optionally use a different number of wires for connecting a different number of lamps.

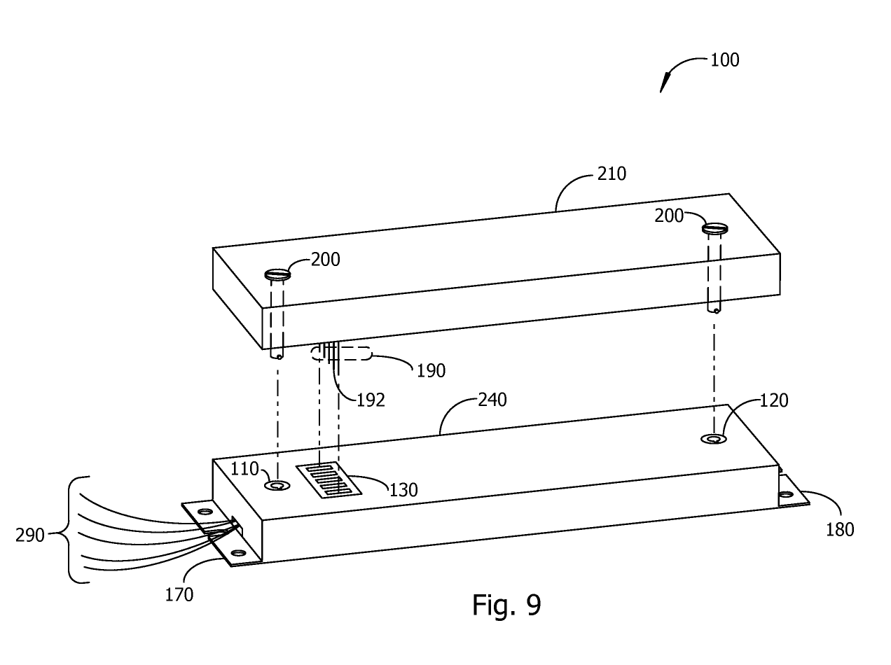

A pictorial view of an example embodiment of an LED PS 210 in position for engagement with an example of a base 240 is shown in FIG. 9. Alternately, FIG. 9 shows an example of an LED PS 210 after it has been detached from the base 240. The captive fasteners 200 and corresponding mating parts (110, 120) in the example of FIG. 9 function as earlier described for embodiments of the invention having a common mechanical interface. In the illustrated example, the LED male coupling 190 includes 5 pins 192. Other embodiments of an LED PS and base 240 may be adapted for electrical connections using a different number of pins 192. The base 240 in the example of FIG. 9 further includes wire connections 290 to the base, including for example two black wires, a white wire for neutral line connection, a green wire for ground connection, and a red wire. Wire color coding may optionally be in accord with National Electrical Code conventions for identifying current-carrying, nutral, and ground conductors. Other embodiments of a base 240 may optionally use a different number of wires.

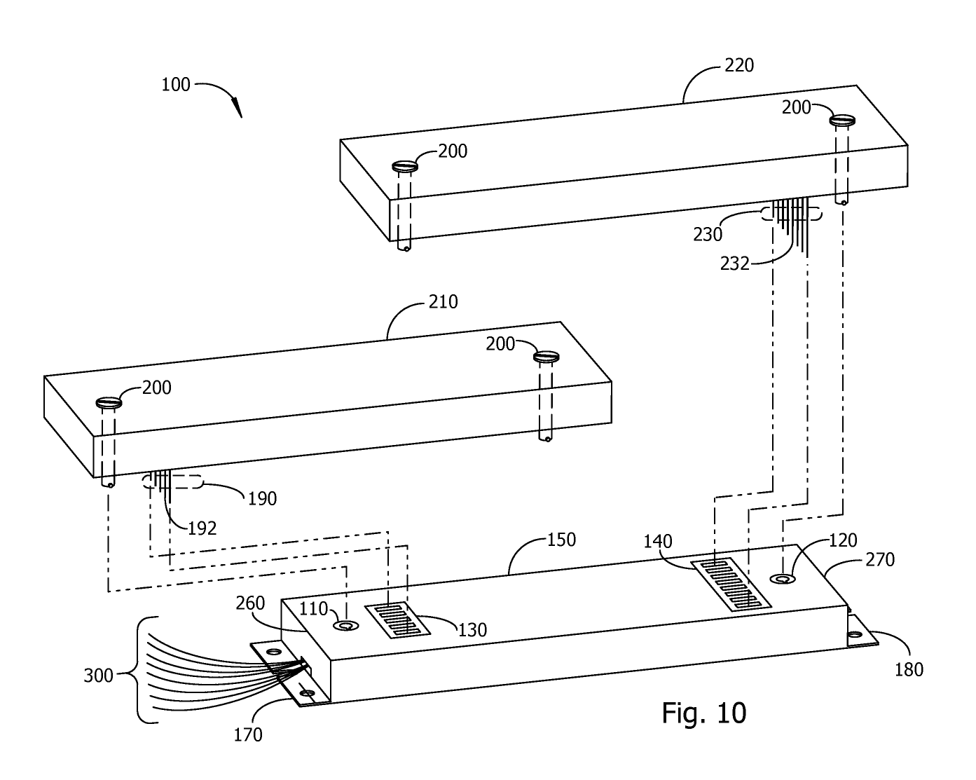

FIG. 10 gives a pictorial view of an example embodiment of a base 150 adapted for electrical and mechanical connection to both a ballast 220 and to an LED PS 210. Only one module may be connected to the base at a time, but the base in the illustrated example is capable of interfacing electrically and mechanically with either type of module. In the illustrated example, the base 150 includes near a fluorescent end 270 a ballast coupling 140 and PSC2 120. The ballast coupling 140 is adapted for engagement with corresponding pins 232 in a ballast male coupling 230 on the ballast 220 when fasteners 200 on the ballast engage with corresponding mating parts (110, 120) on the base 150. The example embodiment of a base 150 also includes near an LED end 260 of the base an LED PS coupling 130 and a PSC1 110. The LED PS coupling 130 is adapted for engagement with corresponding pins 192 in an LED male coupling 190 on the LED PS 210 when fasteners 200 on the LED PS engage with corresponding mating parts on the base 150. The base 150 in the example of FIG. 10 further includes wire connections 300 to the base, including for example four red wires, one yellow wire, one black wire, one white wire, and one green wire. Other embodiments of a base 150 may optionally use a different number of wires for making electrical connections.

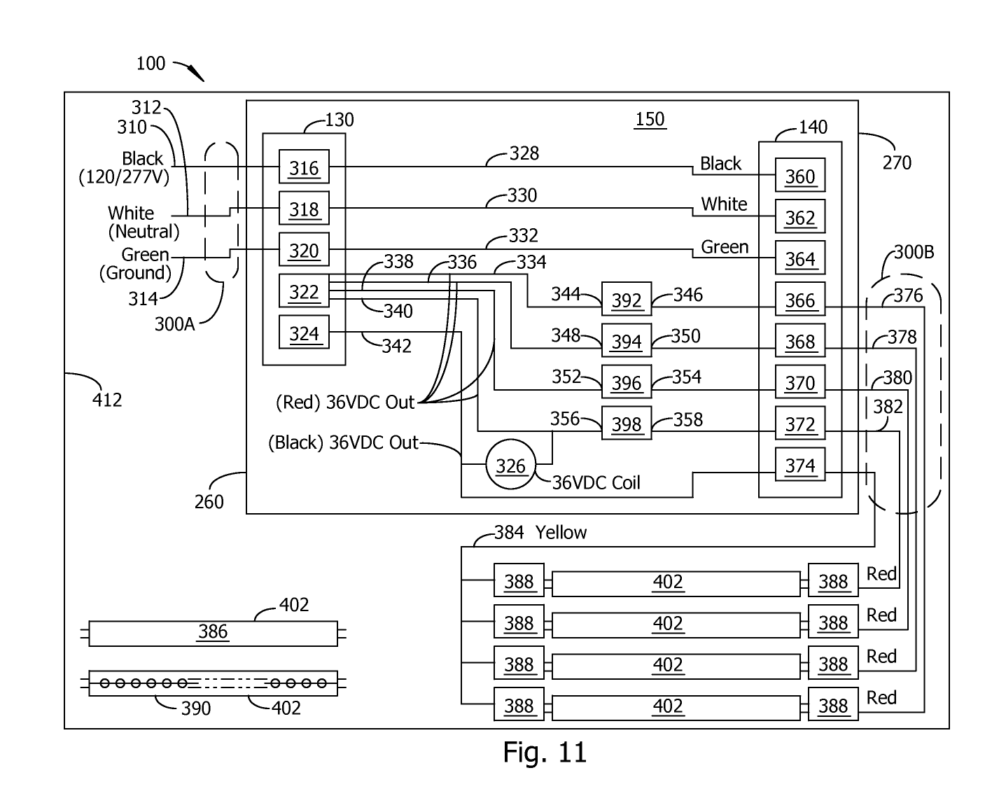

FIG. 11 shows an example of an electrical schematic for an embodiment of the invention 100 comprising the example embodiment of a base 150 of FIGS. 1, 4, 5, and 10. FIG. 11 further illustrates an example of a light fixture 412 embodiment of the invention 100 for holding and operating lamps 402. A lamp 402, the light-emitting component in a light fixture 412, may be a fluorescent lamp 386 or an LED lamp 390. In other embodiments of a light fixture 412, a different number of lamps may be used. In the illustrated example, four lamps 402 are held by eight lamp sockets 388. All four lamps 402 installed in sockets 388 are preferably either fluorescent lamps 386 or all four are LED lamps 390. An LED lamp connected to a fluorescent ballast may be damaged by voltages output by the ballast, and conversely, a fluorescent lamp connected to an LED power supply may fail to light. One group of four lamp sockets 388 is electrically connected by a yellow wire 384 to a socket 374 in the ballast coupling 140. One of the remaining four lamp sockets 388 is connected by a red wire 382 to a socket 372 in the ballast coupling 140. Another of the lamp sockets 388 is connected by a red wire 380 to a socket 370. Another lamp socket 388 is connected by a red wire 378 to a socket 368. Another lamp socket 388 is connected by a red wire 376 to a socket 366 in the ballast coupling 140. The red and yellow wires (376, 378, 380, 382, and 384) may optionally be combined into a wire bundle 300B exiting from the fluorescent end 270 of the base 150.

Continuing with the example of a ballast coupling 140 in FIG. 11, and further continuing with color coding in accord with national Electrical Code conventions, a socket 364 in the ballast coupling 140 is connected by a green wire 332 to a socket 320 in the LED PS coupling 130. A green (ground) wire 314 may optionally be connected to the socket 320. A socket 362 in the ballast coupling 140 is connected by a white wire 330 to a socket 318 in the LED PS coupling 130. A white (neutral) wire 312 may optionally be connected to the socket 318. A socket 360 in the ballast coupling 140 is connected by a black wire 328 to a socket 316 in the LED PS coupling 130. A black wire capable of carrying from 120 to 277 volts (V) may optionally be connected to the socket 316. Wires 310, 312, and 314 may optionally be combined into a wire bundle 300A exiting from the LED end 260 of the base 150. Alternatively, the wires in wire bundles 300A and 300B may be combined into a single wire bundle exiting the base from one end of the base 150.

The socket 374 in the ballast coupling 140 is connected by a black wire 342 to a socket 324 in the LED PS coupling 130. Sockets 372, 370, 368, and 366 are connected to socket 322 through intervening switching devices 398, 396, 394, and 392. Examples of switching devices which may be used in embodiments of a base 150 include, but are not limited to, four separate single-pole single throw manually operated switches, a four-pole single throw manually operated switch, or four switching elements provided as movable parts of sockets in the LED PS coupling 130 or ballast coupling 140. A switching element provided as a movable part of a socket changes switching state when a pin is inserted into the socket. When the switching elements for switching devices 398, 396, 394, and 392 are part of the LED PS coupling 130, the switching elements may be provided as normally open contacts that close when pins from an LED power supply are inserted into the LED PS coupling 130 and re-open when the module is disconnected from the base. Alternatively, when the switching elements for switching devices 398, 396, 394, and 392 are part of the ballast coupling 140, the switching elements may be provided as normally closed contacts that open when pins from a ballast embodiment of the invention are inserted into the ballast coupling 140 and re-close when the module is disconnected from the base.

The first switching device 392 is connected from a first terminal 344 by a red wire 334 to a socket 322 in the LED PS coupling 130. A second terminal 346 on the first switching device 392 is electrically connected to socket 366 in the ballast coupling 140. The second switching device 394 is connected from a first terminal 348 by a red wire 336 to the socket 322 in the LED PS coupling 130. A second terminal 350 on the second switching device 394 is electrically connected to socket 368 in the ballast coupling 140. The third switching device 396 is connected from a first terminal 352 by a red wire 338 to the socket 322 in the LED PS coupling 130. A second terminal 354 on the third switching device 396 is electrically connected to socket 370 in the ballast coupling 140. The fourth switching device 398 is connected from a first terminal 356 by a red wire 340 to the socket 322 in the LED PS coupling 130. A second terminal 358 on the fourth switching device 398 is electrically connected to socket 372 in the ballast coupling 140. A 36 VDC coil 326 is electrically connected between socket 324 in the LED PS coupling 130 and the fourth switching device 398 first terminal 356.

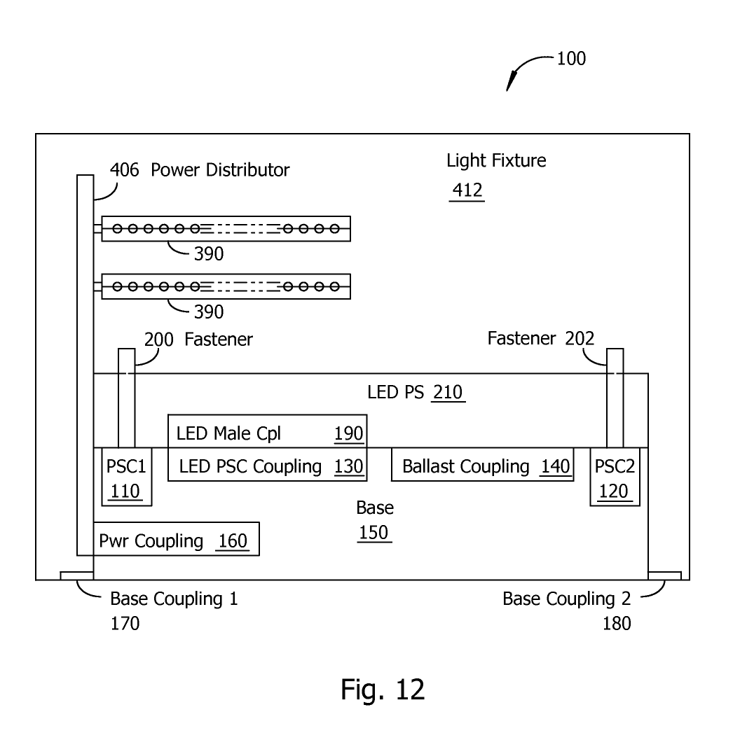

FIG. 12 shows a block diagram of an example of an embodiment of the invention 100 comprising a light fixture 412 for operating LED lamps 390. A light fixture 412 in accord with an embodiment of the invention may include a different number or type of LED lamps than are shown in the illustrated example. As shown in the example of FIG. 12, a light fixture 412 may include a base 150 attached to the fixture by base coupling 1 170 and base coupling 2 180. The base couplings may be provided as threaded fasteners joining the base to the fixture, as clamps, or as other attachment devices permitting the base to be removed from the fixture. Alternatively, a base may be joined to the fixture, for example by being formed as part of the fixture or by welding to the fixture.

The base 150 in the example of FIG. 12 includes an LED power supply coupling 130, an optional ballast coupling 140, at least one power coupling 160, and two mechanical couplings PSC1 110 and PSC2 120 for removable connection of an LED PS module 210. The example of an LED PS 210 in FIG. 12 is shown firmly but removably connected to the base 150 by fasteners 200 engaging PSC1 110 and PSC2 120. An LED male coupling 190 in the LED PS 210 makes electrical connections to the LED PSC coupling 130 in the base 150. A power distributor 406 electrically connected to the power coupling 160 in the base 150 carries voltage and current from the LED PS 210 to the LED lamps 390.

Unless expressly stated otherwise herein, ordinary terms have their corresponding ordinary meanings within the respective contexts of their presentations, and ordinary terms of art have their corresponding regular meanings.

What is claimed is:

1. An apparatus, comprising:
a light emitting diode power supply (LED PS) module comprising a plurality of pin electrical contacts providing for all electrical connections to mains power input and any light emitting diode (LED) lamps; and
a wired base having a plurality of socket electrical contacts for electrical and mechanical connection to said plurality of pin electrical contacts in said LED PS module and for providing intermediate wiring between said LED PS module and said mains power input and any LED lamps.

2. The apparatus of claim 1, further comprising two quick turn fasteners disposed in said LED PS module and providing for removable mechanical connection of said LED PS module to said wired base.

3. The apparatus of claim 1, wherein said plurality of socket electrical contacts in said wired base are provided in a zero insertion force connector.

4. An apparatus, comprising:
a light emitting diode power supply (LED PS) module comprising a plurality of pin electrical contacts providing for all electrical connections to mains power input and any light emitting diode (LED) lamps; and
a wired base comprising:
a first plurality of socket electrical contacts disposed near an LED end of said base and for electrical and mechanical connection to said plurality of pin electrical contacts in said LED PS module and for providing intermediate wiring between said LED PS module and said mains power input and any LED lamps; and
a second plurality of socket electrical contacts disposed near a fluorescent end of said base for electrical and mechanical connection to a corresponding plurality of pin electrical contacts in a ballast module.

5. The apparatus of claim 4, further comprising two quick turn fasteners disposed in said LED PS module and providing for removable mechanical connection of said LED PS module to said wired base.

6. The apparatus of claim 4, further comprising:
said first plurality of socket electrical contacts in said wired base comprise five socket electrical contacts arranged in a group comprising an LED PS coupling for making electrical connections between said base and said LED PS module; and
said second plurality of socket electrical contacts in said wired base comprise eight socket electrical contacts arranged in a group comprising a ballast coupling for making electrical connections between said base and a ballast module.

7. The apparatus of claim 6, wherein said plurality of pin electrical contacts in said LED PS module comprise five pin electrical contacts arranged in a group comprising an LED male coupling for making electrical connections to said LED PS coupling.

8. The apparatus of claim 6, further comprising a ballast module comprising a plurality of pin electrical contacts providing for all electrical connections to mains power input and any fluorescent lamps.

9. The apparatus of claim 6, wherein said base is attached to a light fixture.

10. The apparatus of claim 6, wherein said light fixture is adapted for operation of at least one fluorescent lamp by connection of said ballast to said base.

11. The apparatus of claim 6, wherein said light fixture is adapted for operation of at least one LED lamp by connection of said LED PS to said base.

12. The apparatus of claim 6, wherein said wired base further comprises a plurality of switching devices electrically connected between said LED PS coupling and said ballast coupling, and each of said plurality of switching devices is a normally open switching device that is closed when said LED PS module is connected to said base and opened when said ballast module is connected to said base.

13. The apparatus of claim 12, wherein each of said plurality of switching devices are part of said LED PS coupling in said base.

14. The apparatus of claim 12, wherein said plurality of switching devices comprises:
a first switching device electrically connected to a first socket in said LED PS coupling and to a first socket in said ballast coupling;
a second switching device electrically connected to said first socket in said LED PS coupling and to a second socket in said ballast coupling;
a third switching device electrically connected to said first socket in said LED PS coupling and to a third socket in said ballast coupling; and
a fourth switching device electrically connected to said first socket in said LED PS coupling and to a fourth socket in said ballast coupling.

15. The apparatus of claim 14, further comprising a coil electrically connected from said first socket in said LED PS coupling to a first socket in said ballast coupling.

16. The apparatus of claim 6, further comprising a lighting fixture adapted to operate at least one LED lamp.

17. The apparatus of claim 6, further comprising a lighting fixture adapted to operate at least one fluorescent lamp.

18. The apparatus of claim 6, wherein each of said two quick turn fasteners is a quarter-turn fastener and said base includes two quarter turn fastener receptacles.

19. The apparatus of claim 6, wherein each of said two quick turn fasteners is a half-turn fastener and said base includes two half-turn fastener receptacles.

20. The apparatus of claim 6, wherein each of said two quick turn fasteners is a captive threaded bolt and said base includes two captive threaded nuts.
